(19) United States
(12) Patent Application Publication
(10) Pub. No.: US 2024/0396280 A1
(43) Pub. Date: Nov. 28, 2024

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: RU-FENG SHI, Shenzhen (CN); FU-YOU YANG, Shenzhen (CN); WEN HE, Kunshan (CN)

(21) Appl. No.: 18/669,878

(22) Filed: May 21, 2024

(51) Int. Cl. H01R 43/24

(52) U.S. Cl. CPC H01R 43/24

(57) ABSTRACT

A method of making an electrical connector includes the steps of: molding a first insulator and a separate second insulator with an upper row of contacts and molding an insulator with a lower row of contacts, respectively; bending the upper row of contacts along a region thereof situated between the first insulator and the separate second insulator; bending the lower row of contacts; securing the first insulator and the separate second insulator to the insulator molded with the lower row of contacts; and molding an insulator with the upper and the lower rows of contacts while exposing respective upper and lower contacting portions of the upper and the lower rows of contacts.

### BACKGROUND OF THE INVENTION

### 1. Field of the Invention

The present invention relates to a method of making an electrical connector which has a row of contacts with relatively long vertical portions.

### 2. Description of Related Arts

U.S. Pat. No. 11,670,883 discloses an electrical connector which includes a front tongue with two opposite surfaces and an upper and a lower rows of contacts with contacting portions exposed to the two opposite surfaces of the tongue. Due to relatively long vertical portions of the rows of contacts, in making the electrical connector, a specially designed insulator is molded to the lower row of contacts and then the upper row of contacts are mounted to the insulator by inserting tails of the upper row of contacts through the insulator. A different way of making an electrical connector which has a row of contacts with relatively long vertical portions is desired.

### SUMMARY OF THE INVENTION

A method of making an electrical connector comprises the steps of: molding a first insulator and a separate second insulator with an upper row of contacts and molding an insulator with a lower row of contacts, respectively; bending the upper row of contacts along a region thereof situated between the first insulator and the separate second insulator; bending the lower row of contacts; securing the first insulator and the separate second insulator to the insulator molded with the lower row of contacts; and molding an insulator with the upper and the lower rows of contacts while exposing respective upper and lower contacting portions of the upper and the lower rows of contacts.

### BRIEF DESCRIPTION OF THE DRAWING

FIG. 1 is a perspective view of an electrical connector in accordance with the present invention;

FIG. 2 is a perspective view of the electrical connector from another perspective;

FIG. 3 is an exploded view of the electrical connector in FIG. 1;

FIG. 4 is an exploded view of the electrical connector in FIG. 2;

FIG. 5 is an exploded view of a contact module of the electrical connector;

FIG. 6 is a view similar to FIG. 5 but from another perspective;

FIG. 7 is an exploded view of a part of the contact module;

FIG. 8 is a view similar to FIG. 7 but from another perspective;

FIG. 9 is a cross-sectional view of the electrical connector taken along line A-A in FIG. 1;

FIG. 10 is a cross-sectional view of the electrical connector taken along line B-B in FIG. 1;

FIG. 11 shows intermediate states of manufacturing a part of the contact module;

FIG. 12 shows intermediate states of manufacturing another part of the contact module;

FIG. 13 shows a shielding plate of the contact module; and

FIG. 14 shows another state of manufacturing the contact module.

### DETAILED DESCRIPTION OF THE PREFERRED EMBODIMENT

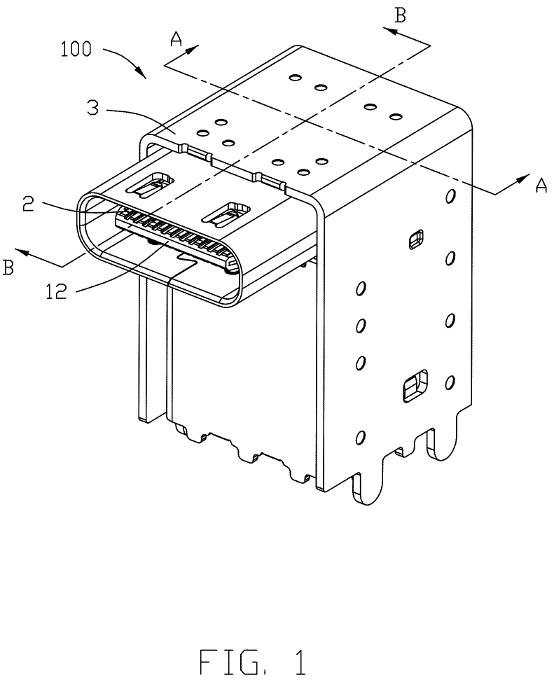

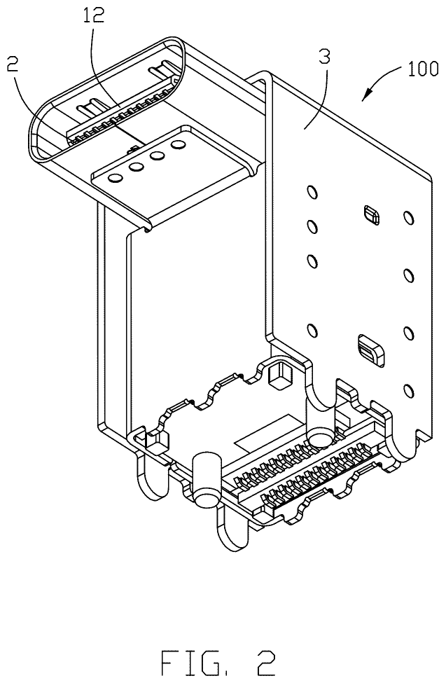

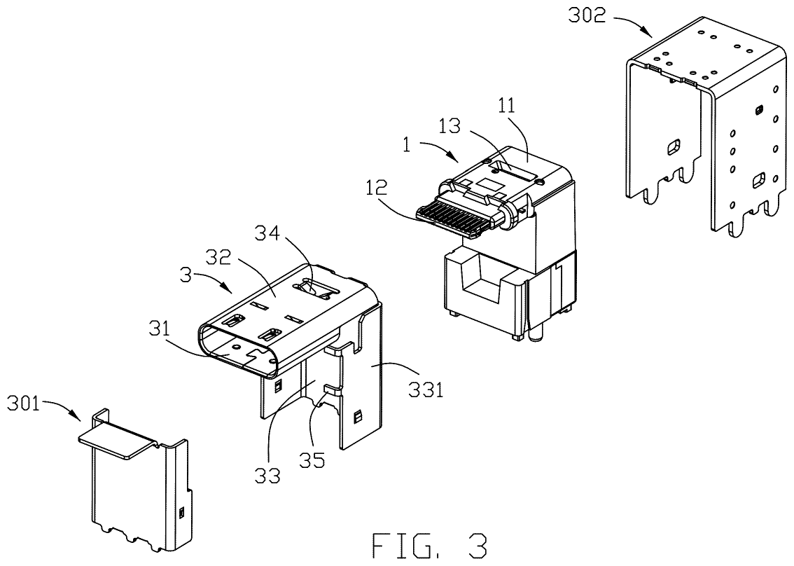

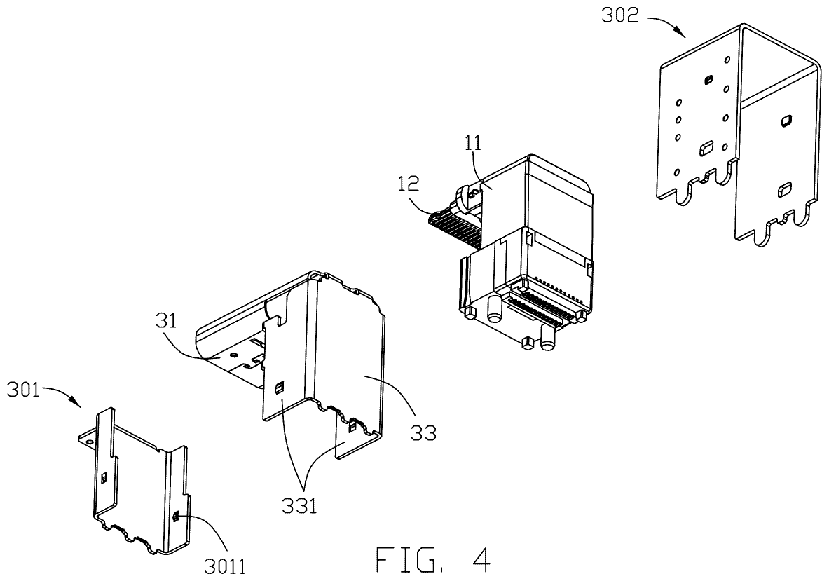

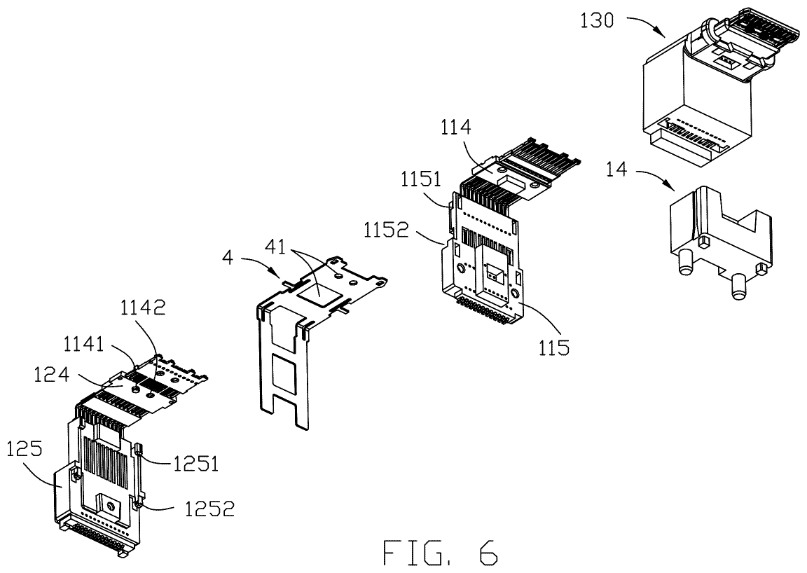

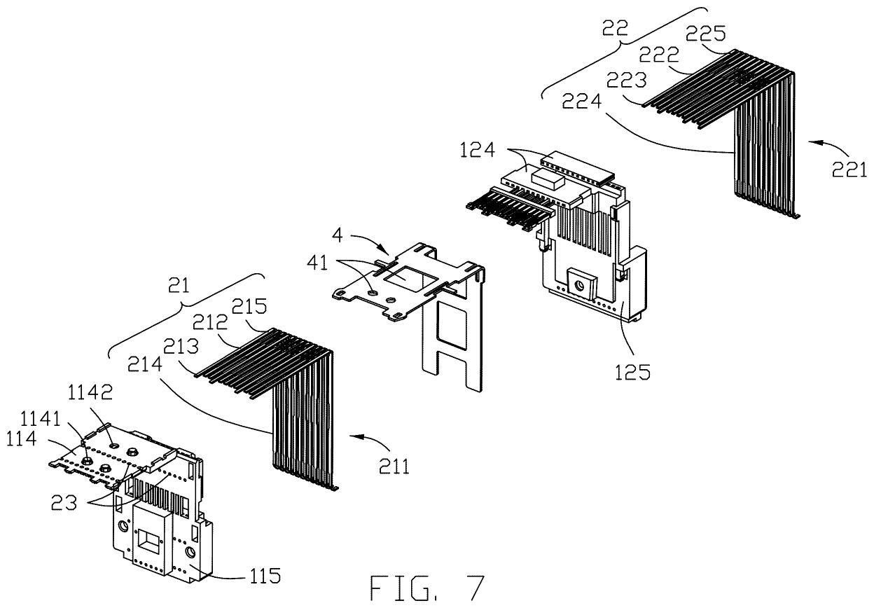

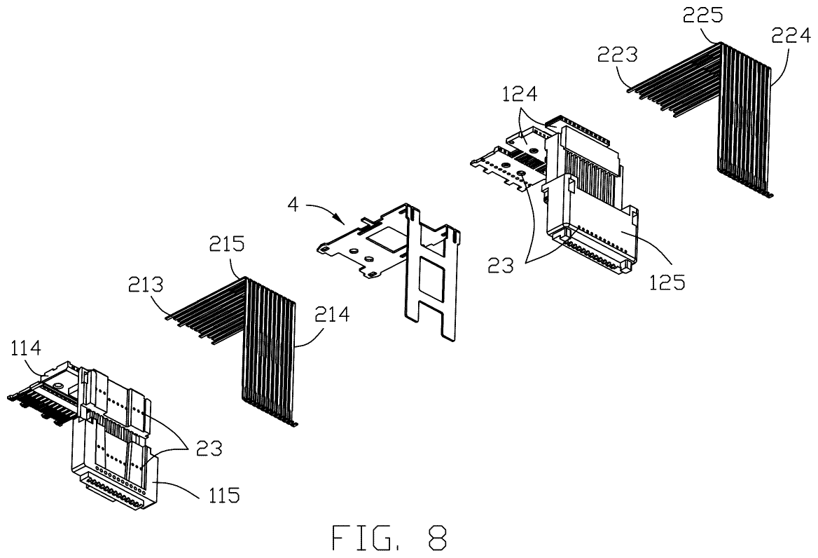

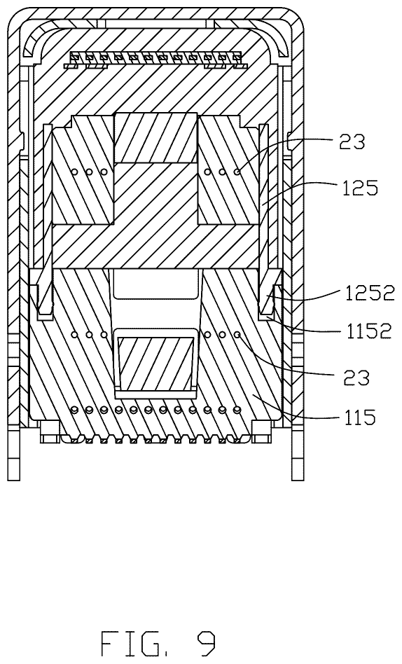

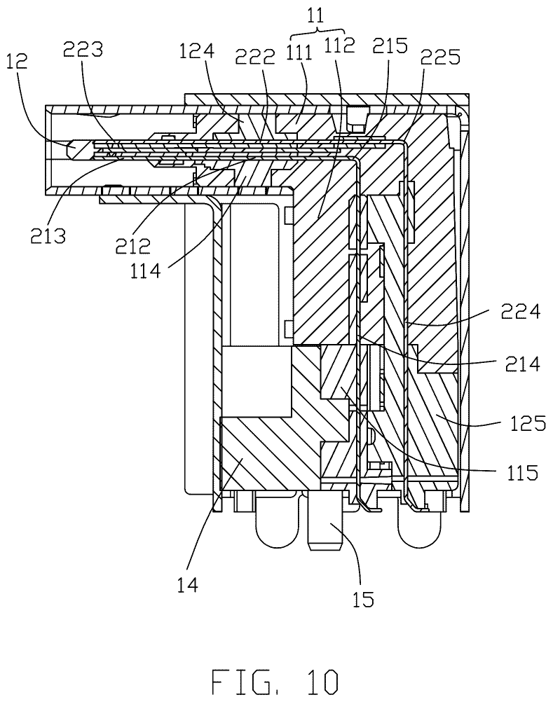

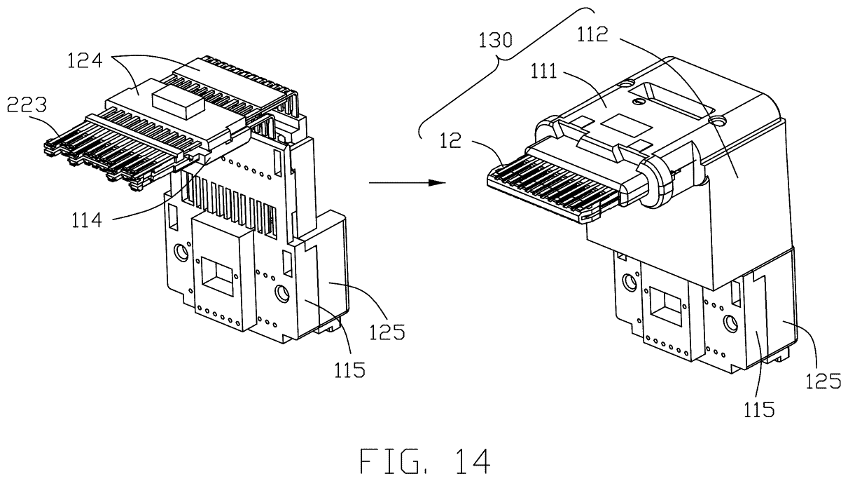

Referring to FIGS. 1-14, particularly FIGS. 1-4, an electrical connector 100 comprises an insulative housing 1 and an upper and a lower rows of contacts 2 secured in the insulative housing 1 to together form a contact module. The electrical connector 100 may further comprise a shielding shell 3 enclosing the contact module and a middle shielding plate 4 between the upper row 221 of contacts 221 and the lower row 211 of contacts. The insulative housing 1 includes a first insulative part 110 molded with the lower row 211 of contacts, a second insulative part 120 molded with the upper row 221 of contacts, and another insulator 130 molded to the first and the second insulative parts 110 and 120. The insulator 130 has a base 11 and a tongue 12. The base 11 has a slot 13 for engaging a pair of fingers 34 of the shielding shell 3. The shielding shell 3 includes a tubular part 31 surrounding the tongue 12, a rear part 32 covering the base 11, and a back cover 33 bent from the rear part 32 for covering a rear of the insulative housing 1. The back cover 33 includes a pair of side walls 331 each having a detent 35. The electrical connector 100 may further include a first auxiliary shell 301 and a second auxiliary shell 302.

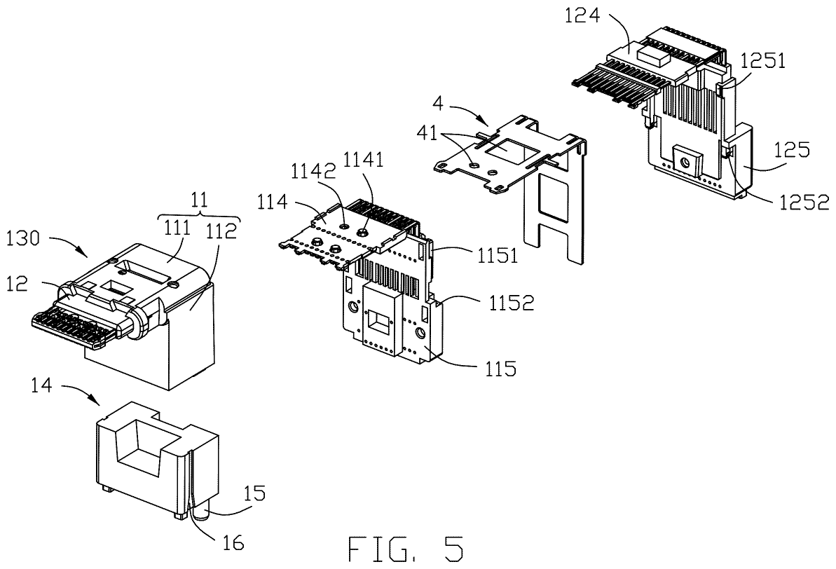

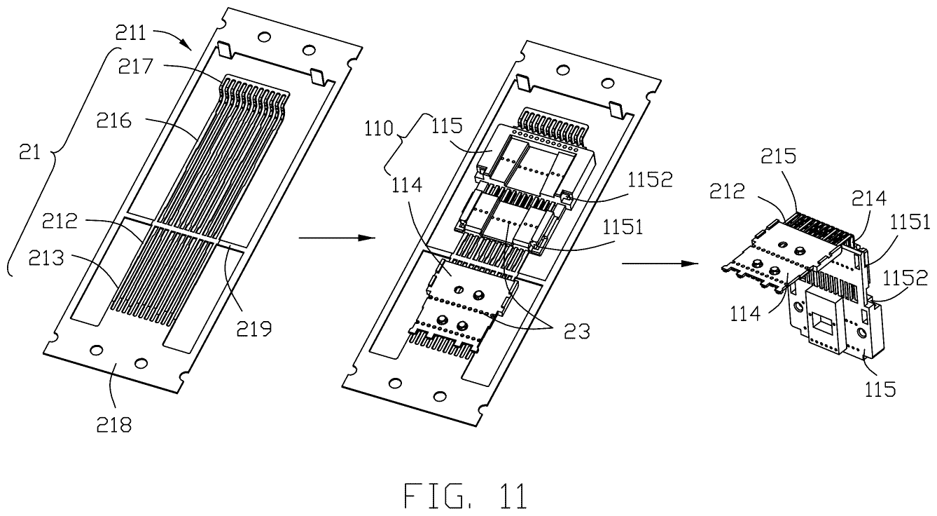

Referring to FIGS. 5-8 in particular, each contact 21 of the lower row 211 has a horizontal securing portion 212, a contacting portion 213 exposed to the tongue 12, and a vertical upright portion 214 extending downward from a bend 215 thereof. Similarly, each contact 22 of the upper row 221 has a horizontal securing portion 222, a contacting portion 223 exposed to the tongue 12, and a vertical upright portion 224 extending downward from a bend 225 thereof. The insulative housing 1 further includes a first insulator 124 molded to the securing portion 222 and the contacting portion 223 and a separate second insulator 125 molded to the upright portion 224. Similarly, the insulative housing 1 further includes a third insulator 114 molded to the securing portion 212 and the contacting portion 213 and a separate fourth insulator 115 molded to the upright portion 214. Holes 23 (FIG. 11) formed during molding operations are seen on the first and the second insulators 114 and 115.

With the first insulator 124 being separate from the second insulator 125 and the third insulator 114 being separate from the fourth insulator 115, after molding operations, each row of contacts are bent at the bends thereof and then the first insulator 124 is secured to the third insulator 114, e.g., through respective posts 1141 and holes 1142 formed on opposing faces thereof, and the second insulator 125 is secured to the fourth insulator 115, e.g., through respective claws 1251, 1252 and holes 1151, 1152 thereof.

The tongue 12 of the insulative housing 1 is over-molded to the first insulator 124 and the third insulator 114. Generally, the base 11 of the insulative housing 1 has a base portion 111 molded over the securing portions 212, 222 and the bends 215, 225 and a mounting portion 112 molded over the second insulator 125 and the fourth insulator 115. The insulative housing 1 may further include a separate support portion 14 having a pair of posts 15 for mounting to an external printed circuit board and a pair of grooves 16 for receiving corresponding protrusions 3011 of the first auxiliary shell 301.

A method of making the electrical connector 100 will be described by reference to FIGS. 11-14.

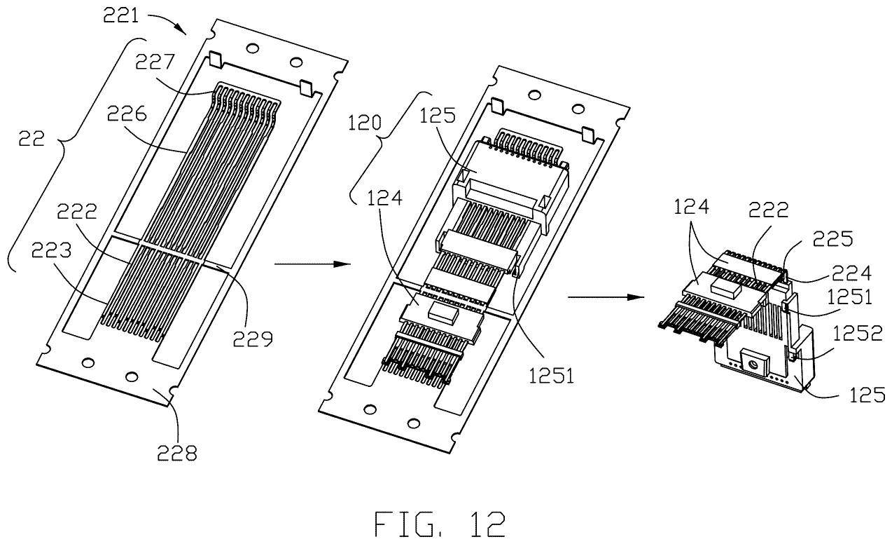

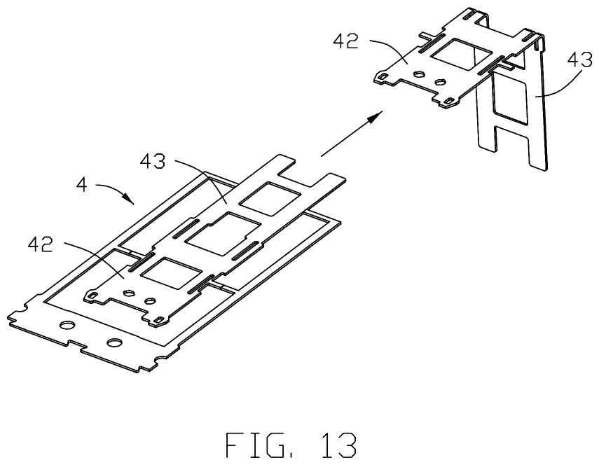

A contact carrier carrying the lower contact row 211 and another contact carrier carrying the upper contact row 221 are prepared, as shown in FIGS. 11 and 12. The shielding plate 4, if present, is also prepared, as shown in FIG. 13. Also shown are separated first insulator 124 and second insulator 125 being molded with the upper row of contacts 22 and the separated third insulator 114 and fourth insulator 115 being molded with the lower row of contacts 21. The contact 21 has a relatively long portion 216 and a tail 217 connected to a bridge that is to be severed; the contact 22 has a relatively long portion 226 and a tail 227 connected to a bridge that is to be severed. The contact carrier has a strip 218 connected to the contacting portion 213 and a bridge 219 situated at a region between the securing portion 212 and the long portion 216 among adjacent contacts 21; the another contact carrier has a strip 228 connected to the contacting portion 223 and a bridge 229 situated at a region between the securing portion 222 and the long portion 226 among adjacent contacts 22.

After molding and severing, the lower row of contacts 21 are bent at the bend 215 and the upper row of contacts 22 are bent at the bend 225, respectively.

After bending, the first insulator 124 and the second insulator 125 are then brought to be secured to the third insulator 114 and the fourth insulator 115, respectively.

Then the insulator 130 is over-molded with the upper and the lower rows of contacts 22, 21 while exposing respective upper and lower contacting portions 223, 213 thereof. As can be understood, the insulator 130 also over-molds other portions or voids the contact module formed by the molded upper contacts and associated insulators and the molded lower contacts and associated insulators. To complete a final electrical connector, the shielding shell 3 and optionally the first auxiliary shell 301 and the second auxiliary shell 302 are assembled accordingly.

1. A method of making an electrical connector, comprising the steps of:
molding a first insulator and a separate second insulator with an upper row of contacts and molding an insulator with a lower row of contacts, respectively;
bending the upper row of contacts along a region thereof situated between the first insulator and the separate second insulator;
bending the lower row of contacts;
securing the first insulator and the separate second insulator to the insulator molded with the lower row of contacts; and
molding an insulator with the upper and the lower rows of contacts while exposing respective upper and lower contacting portions of the upper and the lower rows of contacts.

2. The method as claimed in claim 1, wherein the step of molding the insulator with the lower row of contacts comprises molding a third insulator and a separate fourth insulator, and the step of bending the lower row of contacts comprising bending along a region thereof situated between the third insulator and the separate fourth insulator.

3. The method as claimed in claim 1, further comprising a step of severing a bridge of the upper row of contacts before the step of molding the first insulator and the separate second insulator with the upper row of contacts.

4. The method as claimed in claim 1, further comprising a step of severing a bridge of the lower row of contacts before the step of molding the insulator with the lower row of contacts.

5. The method as claimed in claim 1, further comprising a step of placing a shielding plate between the upper row of contacts and the lower row of contacts before the step of securing.
